(19) United States
(12) Patent Application Publication
(10) Pub. No.: US 2021/0207031 A1
(43) Pub. Date: Jul. 8, 2021

(54) LIQUID CRYSTAL ALIGNMENT FILM, METHOD FOR PRODUCING THE SAME, SUBSTRATE AND DISPLAY DEVICE

(71) Applicants: BOE TECHNOLOGY GROUP CO., LTD., Beijing (CN); CHONGQING BOE OPTOELECTRONICS TECHNOLOGY CO., LTD., Chongqing (CN)

(72) Inventors: Bin WAN, Beijing (CN); Min LI, Beijing (CN); Qiang XIONG, Beijing (CN); Huan NI, Beijing (CN)

(73) Assignees: BOE TECHNOLOGY GROUP CO., LTD., Beijing (CN); CHONGQING BOE OPTOELECTRONICS TECHNOLOGY CO., LTD., Chongqing (CN)

(21) Appl. No.: 16/078,328

(22) PCT Filed: Jan. 31, 2018
(86) PCT No.: PCT/CN2018/074767

§ 371 Date: Aug. 21, 2018

(30) Foreign Application Priority Data
Jul. 24, 2017 (CN) 201710605853.1

(51) Int. Cl. C09K 19/56; C08G 73/10; G02F 1/1337

(52) U.S. Cl. CPC C09K 19/56; C08G 73/1071; G02F 1/133723; C08G 73/1017; C08G 73/1057

(57) ABSTRACT

The present disclosure discloses a liquid crystal alignment film, a method for producing the same, a substrate, and a display device. The liquid crystal alignment film includes a polyimide having a fluorine-containing group, wherein the polyimide is polymerized from dicarboxylic anhydride containing one or more fluorine atoms, a C₁₂₋₂₀ monoamine and a diamine. The introduction of the long flexible chain and the fluorine-containing group allow the pretilt angle of the polyimide synthesized by the present disclosure to reach 3° to 5°, and the introduction of fluorine element remarkably improves the transmittance of the synthesized polyimide and decreases water absorption. The modified fluorine-containing long flexible chain polyimide material prepared may be used in a liquid crystal alignment film of TFT-LCD, and enhance light transmittance, thermal stability, chemical stability, adhesion, etc. of the liquid crystal alignment film, thereby avoiding related defects caused by polyimide materials.

### CROSS-REFERENCE TO RELATED APPLICATION

This application is the U.S. national phase of PCT Application No. PCT/CN2018/074767 filed on Jan. 31, 2018, which claims priority to Chinese Patent Application No. 201710605853.1 filed on Jul. 24, 2017, which are incorporated herein by reference in their entireties.

### TECHNICAL FIELD

The present disclosure relates to the field of display device technology, in particular to a liquid crystal alignment film, a method for producing the same, a substrate, and a display device.

### BACKGROUND

In the field of thin film transistor liquid crystal display (TFT-LCD) technology, an alignment film coated on a color film (CF) substrate and a thin film transistor (TFT) substrate functions to control the alignment direction of liquid crystal molecules. Since there is a strong force at the interface between the liquid crystal and the alignment film, the liquid crystal molecules, whose alignment directions have been changed, return to the original state by viscoelasticity after the applied voltage is removed.

The current polymer materials for LCD alignment films are usually polyimides (PIs). The thickness of the alignment film of the TFT-LCD is usually 500 to 1500 Å. Since the alignment film has a relative thin thickness and should withstand a rubbing alignment, it is required that the material of the alignment film must have a high mechanical strength. In addition, the alignment pattern formed by rubbing in the manufacturing process should withstand a high temperature of 200° C., and the material of the alignment film should also have a good affinity to the liquid crystal, but may not react with the liquid crystal. The current most commonly used alignment is the rubbing alignment. The rubbing alignment means that a contact-type directional mechanical rubbing is performed on the surface of polymer PI by a flannel roller, and the energy supplied by rubbing the surface of the polymer allow the main chain of the polymer extend and directionally align, thereby controlling the alignment of the liquid crystal. The method has the following advantages: it may be performed at a room temperature, and have a short rubbing time and a high productivity. However, this method has the following disadvantages: due to the high polarity, the high water absorption and other features of common polyimide materials, the polyimide material readily degenerates in the storage or transportation process, resulting in an uneven alignment; dust particles, static residues, brush marks and other problems caused by rubbing are also readily decrease the process yield; and the currently used polyimide alignment film generally has a poor transparency and an insufficient light transmittance, thereby affecting the transmittance of the entire TFT-LCD panel.

### SUMMARY

Some embodiments of the present disclosure provide a liquid crystal alignment film, a method for producing the same, and a substrate and a display device comprising the liquid crystal alignment film.

According to one aspect of the present disclosure, the present disclosure provides a liquid crystal alignment film, including polyimide having a fluorine-containing group, wherein the polyimide having the fluorine-containing group is polymerized from dicarboxylic anhydride containing one or more fluorine atoms represented by formula (1), a diamine represented by formula (2) and a monoamine represented by formula (3):

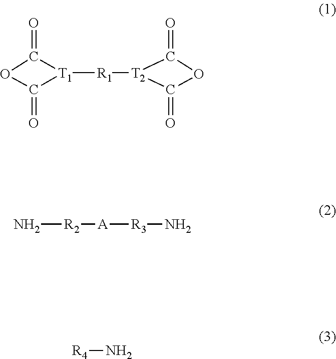

in which

in the formula (1), T₁ and T₂ each are a linking group in a form of an aromatic ring, a C₃₋₁₀ aliphatic ring, a fluorine-containing aromatic ring or a fluorine-containing C₃₋₁₀ aliphatic ring, and R₁ is a C₁₋₁₀ linear alkylene group or a fluorine-containing C₁₋₁₀ linear alkylene group, an aliphatic cycloalkylene group or a fluorine-containing aliphatic cycloalkylene group, an arylene group or a fluorine-containing arylene group, or an aryloxy group or a fluorine-containing aryloxy group;

in the formula (2), R₂ and R₃ each are a linking group in a form of a C₆₋₁₀ aromatic ring or a C₄₋₈ aliphatic ring, or a single bond, A is O, N, S, a C₁₋₅ alkylene group, a single bond or a cyano-substituted alkenylene; and

in the formula (3), R₄ is a C₁₂₋₂₀ alkyl group.

Optionally, the monoamine is a C₁₂₋₂₀ chain aliphatic monoamine.

Optionally, the polyimide contains a trifluoromethyl group or a hexafluoropropyl group derived from R₁ in the formula (1), and the polyimide further contains a C₁₂₋₂₀ linear alkyl group derived from R₄ in the formula (3).

Optionally, the dicarboxylic anhydride containing the one or more fluorine atoms is aromatic dicarboxylic anhydride.

Optionally, the dicarboxylic anhydride containing the one or more fluorine atoms is at least one of 4,4′-(hexafluoroisopropylidene)diphthalic anhydride, 4,4′-[2-(3′-trifluoromethyl-phenyl)-1,4-phenylenedioxy]-diphthalic anhydride and 4,4′-[2-(3′,5′-bis(trifluoromethyl)-phenyl)-1,4-phenylenedioxy]-diphthalic anhydride; the diamine is at least one of 4,4-diaminodiphenyl ether, 4,4-diaminodiphenylmethane, diaminomaleonitrile and 3,3′-dimethyl-4,4-diaminodicyclohexylmethane; and the monoamine is at least one of dodecylamine, tetradecylamine, hexadecylamine and octadecylamine.

Optionally, a molar ratio of the diamine to dicarboxylic anhydride containing the one or more fluorine atoms is from 1:1.1 to 1:1.3.

Optionally, a molar ratio of the monoamine to the diamine is from 1:9 to 1:12.

According to another aspect of the present disclosure, the present disclosure provides a method for producing a liquid crystal alignment film, including steps of:

dissolving dicarboxylic anhydride containing one or more fluorine atoms, a diamine, and a silane coupling agent into an organic solvent for polymerization;

adding a monoamine for addition polymerization of the monoamine, after the polymerization is completed;

adding a fluorine-containing polysiloxane to obtain a prepolymer polyamic acid solution, after the addition polymerization of the monoamine is completed; and

forming a prepolymer polyamic acid on a substrate and curing the prepolymer polyamic acid to obtain the liquid crystal alignment film.

Optionally, the polymerization is performed at a room temperature.

Optionally, the addition polymerization of the monoamine is performed at a room temperature.

Optionally, the dicarboxylic anhydride containing the one or more fluorine atoms is at least one of 4,4′-(hexafluoroisopropylidene)diphthalic anhydride, 4,4′-[2-(3′-trifluoromethyl-phenyl)-1,4-phenylenedioxy]-diphthalic anhydride or 4,4′-[2-(3′,5′-bis(trifluoromethyl)-phenyl)-1,4-phenylenedioxy]-diphthalic anhydride; the diamine is at least one of 4,4-diaminodiphenyl ether, 4,4-diaminodiphenylmethane, diaminomaleonitrile and 3,3′-dimethyl-4,4-diaminodicyclohexylmethane; and the monoamine is at least one of dodecylamine, tetradecylamine, hexadecylamine and octadecylamine.

Optionally, the silane coupling agent is dimethyldimethoxysilane, isocyanatopropyltrimethoxysilane, or isobutyltriethoxysilane.

Optionally, the silane coupling agent is added in an amount of 0.1% to 0.5% by mass based on the total mass of reactants.

Optionally, a molar ratio of the diamine to dicarboxylic anhydride containing the one or more fluorine atoms is from 1:1.1 to 1:1.3.

Optionally, a molar ratio of the monoamine to the diamine is from 1:9 to 1:12.

Optionally, the fluorine-containing polysiloxane is polytrifluoromethyltrimethylsilane, fluorine-containing hydroxy polysiloxane, fluorine-containing octamethylcyclotetrasiloxane or polydimethylsiloxane.

Optionally, the prepolymer polyamic acid solution has a solid content of 1% to 10%.

Optionally, the curing is performed through: heating the prepolymer polyamic acid to 120 to 150° C. for 2 to 3 hours, and then heating the prepolymer polyamic acid to 250° C. to 300° C. for 2 to 3 hours.

According to one yet aspect of the present disclosure, a substrate including the liquid crystal alignment film described in the above aspects or the liquid crystal alignment film prepared by the method in the above aspects is provided.

According to one further aspect of the present disclosure, a display device including the substrate is provided.

### BRIEF DESCRIPTION OF THE DRAWINGS

FIG. 1 is a flow chart showing a synthesis of 4,4′-(hexafluoroisopropylidene)diphthalic anhydride.

FIG. 2 is a schematic view showing an application process of a liquid crystal alignment film.

FIG. 3 is a diagram showing a synthetic route of a liquid crystal alignment film according to an embodiment of the present disclosure.

### DETAILED DESCRIPTION

In order to better understand the present disclosure, the preferred embodiments of the present disclosure will be described below in combination with embodiments, but it should be understood that these descriptions are merely used to further illustrate the features and advantages of the present disclosure and are not intended to limit the present disclosure.

Embodiments of the present disclosure disclose a liquid crystal alignment film, including polyimide having a fluorine-containing group, wherein the polyimide having the fluorine-containing group is polymerized from dicarboxylic anhydride containing one or more fluorine atoms represented by formula (1), a diamine represented by formula (2) and a monoamine represented by formula (3):

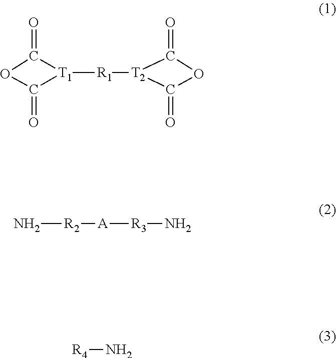

in which

in the formula (1), T₁ and T₂ each are a linking group in a form of an aromatic ring, a C₃₋₁₀ aliphatic ring, a fluorine-containing aromatic ring or a fluorine-containing C₃₋₁₀ aliphatic ring, for example, T₁ and T₂ each may be a C₆₋₁₀ aromatic or C₃₋₁₀ aliphatic ring, or a fluorine-containing C₆₋₁₀ aromatic or C₃₋₁₀ aliphatic ring, or even a 1,2,4-phenyl or 1,2,4-cyclohexyl group; and R₁ is a C₁₋₁₀ linear alkylene group or a fluorine-containing C₁₋₁₀ linear alkylene group, an aliphatic cycloalkylene group or a fluorine-containing aliphatic cycloalkylene group, an arylene group or a fluorine-containing arylene group, or an aryloxy group or a fluorine-containing aryloxy group, for example, R₁ may be hexafluoroisopropyl or 2-(3′-trifluoromethyl-phenyl)-1,4-phenylenedioxy or 2-(3′,5′-bis(trifluoromethyl)-phenyl)-1,4-phenylenedioxy;

in the formula (2), R₂ and R₃ each are a linking group in a form of a C₆₋₁₀ aromatic ring or a C₄₋₈ aliphatic ring, or a single bond, for example, R₂ and R₃ each are 1,4-phenylene group or 1,4-cyclohexylene; A is O, N, S, a C₁₋₅ alkylene group, a single bond or a cyano-substituted alkenylene; and

in the formula (3), R₄ is a C₁₂₋₂₀ alkyl group.

In the present disclosure, the liquid crystal alignment film includes or consists of polyimide having a fluorine-containing group, wherein the polyimide is polyimide modified by one or more fluorine atoms and a long flexible chain segment. Specifically, the polyimide is polymerized from dicarboxylic anhydride containing one or more fluorine atoms, a diamine and a C₁₂₋₂₀ aliphatic monoamine. The introduction of a fluorine-containing group into polyimide through dicarboxylic anhydride containing one or more fluorine atoms may increase the distance between molecular chains and decrease the intermolecular force, thereby allowing it to be dissolved in various organic solvents. Moreover, the relatively strong hydrophobicity of the one or more fluorine atoms greatly decreases the hygroscopicity of polyimide articles, while the relatively low molar polarizability of the polyimide having the fluorine-containing group results in a relatively low dielectric constant thereof. Since the one or more fluorine atoms have a considerable electronegativity, it may destroy the conjugation of the electron cloud having a chromogenic group in the molecular structure of the polyimide, and thus may greatly enhance the light transmittance of the polymer. The dicarboxylic anhydride containing one or more fluorine atoms is optionally aromatic dicarboxylic anhydride containing one or more fluorine atoms, or even optionally at least one of 4,4′-(hexafluoroisopropylidene)diphthalic anhydride, 4,4′-[2-(3′-trifluoromethyl-phenyl)-1,4-phenylenedioxy]-diphthalic anhydride and 4,4′-[2-(3′,5′-bis(trifluoromethyl)-phenyl)-1,4-phenylenedioxy]-diphthalic anhydride.

The present disclosure also introduces a long flexible chain segment into the polyimide through a C₁₂₋₂₀ monoamine. The introductions of the long flexible chain segment and of the one or more fluorine atoms have a synergistic effect, which may increase the heat resistance, the adhesion and the pretilt angle of the polyimide. The pretilt angle may be increased from 1°-2° to 3°-5°. The C₁₂₋₂₀ monoamine is optionally a chain aliphatic monoamine, or even optionally a linear aliphatic monoamine. For example, the monoamine may be at least one of dodecylamine, tetradecylamine, hexadecylamine, and octadecylamine.

In one embodiment of the present disclosure, the diamine is optionally at least one of 4,4-diaminodiphenyl ether, 4,4-diaminodiphenylmethane, diaminomaleonitrile and 3,3′-dimethyl-4,4-diaminodicyclohexylmethane.

Optionally, the polyimide polymerized from dicarboxylic anhydride containing one or more fluorine atoms, a diamine, and a monoamine contains a trifluoromethyl group or a hexafluoropropyl group derived from R₁ in the formula (1), and further contains a C₁₂₋₂₀ linear alkyl group derived from R₄ in the formula (3).

Embodiments of the present disclosure further disclose a method for producing a liquid crystal alignment film, including steps of:

dissolving dicarboxylic anhydride containing one or more fluorine atoms, a diamine, and a silane coupling agent into an organic solvent for polymerization;

adding a monoamine for addition polymerization of the C₁₂₋₂₀ monoamine, after the polymerization is completed;

adding a fluorine-containing polysiloxane to obtain a prepolymer polyamic acid solution, after the addition polymerization of the monoamine is completed; and

forming a prepolymer polyamic acid on a substrate and curing the prepolymer polyamic acid to obtain the liquid crystal alignment film.

In the above method according to the present disclosure, firstly, dissolving dicarboxylic anhydride containing one or more fluorine atoms, a diamine, and a silane coupling agent into an organic solvent for polymerization; adding a monoamine for addition polymerization of the C₁₂₋₂₀ monoamine, after the polymerization is completed; and adding a fluorine-containing polysiloxane to obtain a prepolymer polyamic acid solution, after the addition polymerization of the monoamine is completed.

In the process of synthesizing the prepolymer polyamic acid solution, the dicarboxylic anhydride containing one or more fluorine atoms is optionally aromatic dicarboxylic anhydride containing one or more fluorine atoms, or even optionally at least one of 4,4′-(hexafluoroisopropylidene)diphthalic anhydride, 4,4′-[2-(3′-trifluoromethyl-phenyl)-1,4-phenylenedioxy]-diphthalic anhydride and 4,4′-[2-(3′,5′-bis(trifluoromethyl)-phenyl)-1,4-phenylenedioxy]-diphthalic anhydride.

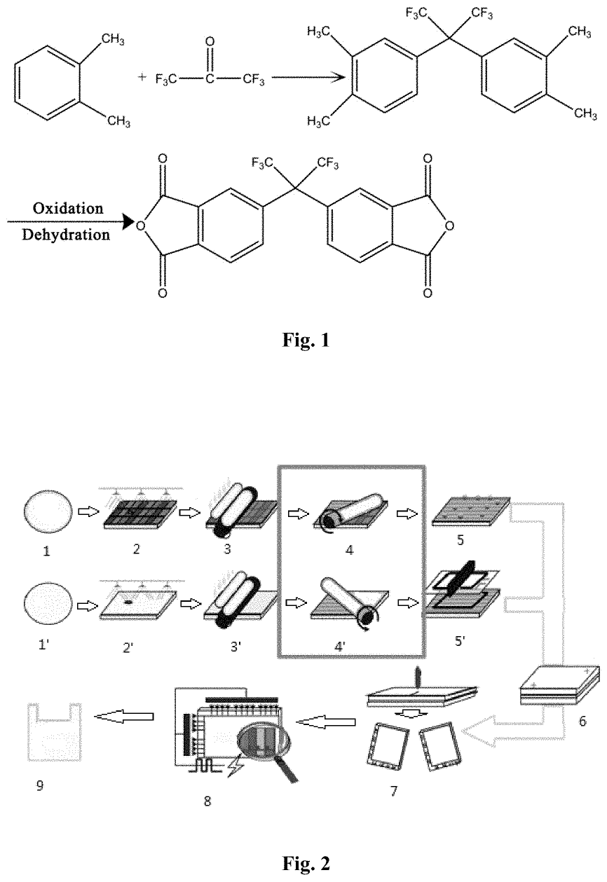

The preparation method for 4,4′-(hexafluoroisopropylidene)diphthalic anhydride is, for example, shown as follows: o-xylene reacts with hexafluoroacetone to form hexafluoro-o-xylene, and then the latter is oxidatively dehydrated to form 4,4′-(hexafluoroisopropylidene)diphthalic anhydride (6FDA). The flow chart for the synthesis of 4,4′-(hexafluoroisopropylidene)diphthalic anhydride is shown in FIG. 1.

The diamine is optionally 4,4-diaminodiphenyl ether, 4,4-diaminodiphenylmethane, diaminomaleonitrile or 3,3′-dimethyl-4,4-diaminodicyclohexylmethane.

The molar ratio of the diamine to dicarboxylic anhydride containing one or more fluorine atoms is optionally 1:1.1 to 1:1.3.

The silane coupling agent functions to increase the degree of coupling polymerization, while it has an anti-hygroscopic effect and improves the water absorption resistance of the polyimide material. The silane coupling agent is, for example, dimethyldimethoxysilane, isocyanatopropyltrimethoxysilane, or isobutyltriethoxysilane. The silane coupling agent may be added in an amount of 0.1% to 0.5% by mass based on the total mass of reactants, which include dicarboxylic anhydride containing one or more fluorine atoms, a diamine and a C₁₂₋₂₀ aliphatic monoamine.

Dicarboxylic anhydride containing one or more fluorine atoms, a diamine, and a silane coupling agent are dissolved into an organic solvent for polymerization, in which the polymerization temperature is room temperature, and the polymerization time is, for example, 4 to 5 hours. The room temperature as referred to herein means a temperature range of 20° C.±5° C.

A monoamine is added for addition polymerization of the C₁₂₋₂₀ monoamine, after the polymerization is completed. In order to avoid termination of the polymerization and lead to the molecular weight of the polymer insufficient, the C₁₂₋₂₀ monoamine have to be added after the polymerization of the dicarboxylic anhydride containing one or more fluorine atoms and the diamine is completed.

The C₁₂₋₂₀ monoamine is optionally a chain aliphatic monoamine, or even optionally a linear aliphatic monoamine. For example, it is at least one of dodecylamine, tetradecylamine, hexadecylamine, and octadecylamine. The molar ratio of the C₁₂₋₂₀ monoamine to the diamine is 1:9 to 1:12. When the C₁₂₋₂₀ monoamine is added to continue the reaction, the reaction temperature is optionally room temperature, and the reaction time is optionally 3 to 4 hours. The room temperature as referred to herein means a temperature range of 20° C.±5° C.

A fluorine-containing polysiloxane is added to obtain a prepolymer polyamic acid solution, after the addition polymerization is completed. The fluorine-containing polysiloxane functions to decrease the surface energy of the material, and to decrease the water content. The fluorine-containing polysiloxane is, for example, polytrifluoromethyltrimethylsilane, fluorine-containing hydroxy polysiloxane, fluorine-containing octamethylcyclotetrasiloxane or polydimethylsiloxane. The fluorine-containing polysiloxane may be added in an amount of 0.1% to 3% by mass based on the total mass of the prepolymer polyamic acid solution. The prepolymer polyamic acid solution may have a solid content of 1% to 10%, for example, 5% to 8% or even 6%.

According to one embodiment of the present disclosure, after obtaining a prepolymer polyamic acid solution, the prepolymer polyamic acid solution is formed on a substrate (for example, uniformly coated onto a substrate) and curing the prepolymer polyamic acid to obtain a liquid crystal alignment film. The curing is optionally performed through: heating the prepolymer polyamic acid to 120° C. to 150° C. for 2 to 3 hours, and then heating the prepolymer polyamic acid to 250° C. to 300° C. for 2 to 3 hours. After the heating, the polyamic acid solution is dehydrated and condensed to form a polyimide film, i.e., a liquid crystal alignment film, on the substrate.

According to one yet aspect of the present disclosure, a substrate including the liquid crystal alignment film described in the above aspects or the liquid crystal alignment film prepared by the method in the above aspects is provided. The substrate may be a color film substrate, or a TFT substrate. The surface of the liquid crystal alignment film is rubbed by means of rubbing alignment to form a groove on the surface thereof, and the chains on long flexible molecular side of the polyimide for forming the liquid crystal alignment film are arranged in the groove direction and formed in a certain pretilt angle.

The application process of the liquid crystal alignment film is shown in FIG. 2. In FIG. 2, step 1 is to provide a base for the color filter substrate; step 2 is to clean the substrate for the color filter substrate; step 3 is to lay a liquid crystal alignment film; step 4 is to align; step 5 is to set the sealant; step 1′ is to provide a base for the TFT substrate; step 2′ is to clean the base for the TFT substrate; step 3′ is to lay an alignment film; step 4′ is to align; step 5′ is to seal a frame; step 6 is to vacuum; step 7 is to form a substrate; step 8 is to test; and step 9 is to form a display component.

According to one further aspect of the present disclosure, a display device including the substrate is provided.

After testing, the liquid crystal alignment film prepared by the present disclosure may have an adhesive force of level 1 and a pretilt angle of 3° to 5°, and thus meet requirements for product. At the same time, the good light transmittance, thermal stability and chemical stability of the liquid crystal alignment film avoids related defects of the liquid crystal alignment film and the substrate caused by polyimide materials.

In one embodiment of the present disclosure, a fluorine-containing group is introduced into polyimide through dicarboxylic anhydride containing one or more fluorine atoms, and a long flexible chain segment is introduced into the polyimide through a C₁₂₋₂₀ monoamine. The introduction of the long flexible chain and the fluorine-containing group allow the pretilt angle of the synthesized polyimide to reach 3° to 5°, and the introduction of fluorine element remarkably improves the light transmittance of the synthesized polyimide. The modified fluorine-containing long flexible chain polyimide material prepared may be used in a liquid crystal alignment film of TFT-LCD, and enhance light transmittance, thermal stability, chemical stability, adhesion, etc. of the liquid crystal alignment film, thereby avoiding related defects caused by polyimide materials.

In order to further understand the present disclosure, the liquid crystal alignment film, the method for producing the same, the substrate, and the display device provided by the present disclosure will be described in detail in the following embodiments, but the protection scope of the present disclosure is not limited by the following embodiments.

In an embodiment of the present disclosure, in N-methylpyrrolidone, 120 g of 4,4′-(hexafluoroisopropylidene)diphthalic anhydride, 100 g of 4,4-diaminodiphenyl ether and 0.221 g of dimethyldimethoxysilane were dissolved and reacted at room temperature for 4 hours. Then, 1 g of dodecylamine was added and continued reacting at a room temperature. After completion of the reaction for 3 hours, 5 g of polytrifluoromethyltrimethylsilane was added to obtain a prepolymer polyamic acid solution having a solid content of 6%.

The prepolymer polyamic acid was uniformly coated onto a substrate, then heated to 120° C. for 3 hours, and further heated to 250° C. for 3 hours, to obtain a liquid crystal alignment film.

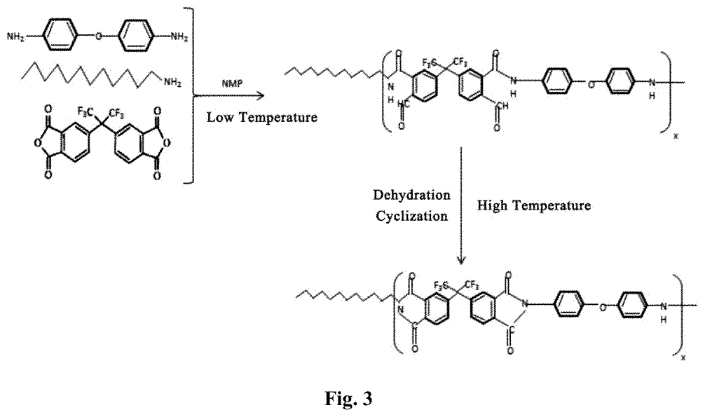

FIG. 3 is a diagram for a synthetic route of a liquid crystal alignment film. 4,4′-(hexafluoroisopropylidene)diphthalic anhydride, 4,4-diaminodiphenyl ether, and dodecylamine were polymerized to produce a polyamic acid solution, which then was dehydrated and cyclized to obtain a liquid crystal alignment film composed of polyimide.

The adhesion of the prepared liquid crystal alignment film was measured by the adhesion tester according to the GB 1720-1979 test standard. The experimental result showed that its adhesion may exceed level 1.

The pretilt angle of the liquid crystal alignment film was measured by PAT-20 type pretilt angle tester from Changchun Liancheng Instrument Co., Ltd. according to crystal rotation method. The experimental result showed that the pretilt angle was 3° to 5°.

The thermal stability of the liquid crystal alignment film was measured by TG (TG209C, NETZSCH, Germany) thermogravimetric analyzer. The temperature range was from 40° C. to 700° C., and the heating rate was selected to be 10 K/min. The result showed that a significant mass loss existed at 550° C. or above, and the mass loss at 700° C. or less merely was 30%. Therefore, its thermal stability is better.

In addition, the test results of the light transmittance and water absorbability of the liquid crystal alignment film showed that the light transmittance of the liquid crystal alignment film was 93.5%; the water absorption merely was 4250 ppm at 25° C. and 18% humidity for 24 hours. The above performances were superior to those of the existing alignment film of polyimide material.

In another embodiment of the present disclosure, in N-methylpyrrolidone, 130 g of 4,4′-(2-(3′-trifluoromethyl-phenyl)-1,4-phenoxy)-phthalic anhydride, 100 g of 4,4-diaminodiphenylmethane and 1.26 g of dimethyldimethoxysilane were dissolved and reacted at a room temperature for 4.5 hours. Then, 2 g of tetradecylamine was added and continued reacting at a room temperature. After completion of the reaction for 3.5 hours, 5 g of fluorine-containing octamethylcyclotetrasiloxane was added to obtain a prepolymer polyamic acid solution having a solid content of 8%.

The prepolymer polyamic acid was uniformly coated onto a substrate, then heated to 140° C. for 2.5 hours, and further heated to 280° C. for 2.5 hours, to obtain a liquid crystal alignment film.

The adhesion of the prepared liquid crystal alignment film was measured by the adhesion tester according to the GB 1720-1979 test standard. The experimental result showed that its adhesion may exceed level 1.

The pretilt angle of the liquid crystal alignment film was measured by PAT-20 type pretilt angle tester from Changchun Liancheng Instrument Co., Ltd. according to crystal rotation method. The experimental result showed that the pretilt angle was 3° to 5°.

The thermal stability of the liquid crystal alignment film was measured by TG (TG209C, NETZSCH, Germany) thermogravimetric analyzer. The temperature range was from 40° C. to 700° C., and the heating rate was selected to be 10 K/min. The result showed that a significant mass loss existed at 550° C. or above, and the mass loss at 700° C. or less merely was 30%. Therefore, its thermal stability is better.

In addition, the test results of the light transmittance and water absorbability of the liquid crystal alignment film showed that the light transmittance of the liquid crystal alignment film was 94.5%; the water absorption merely was 4150 ppm at 25° C. and 18% humidity for 24 hours. The above performances were superior to those of the existing alignment film of polyimide material.

In still another embodiment of the present disclosure, in N-methylpyrrolidone, 150 g of 4,4′-(2-(3′,5′-bis(trifluoromethyl)-phenyl)-1,4-phenoxy)-phthalic anhydride, 100 g of 4,4-diaminodiphenyl ether and 0.69 g of isocyanatopropyltrimethoxysilane were dissolved and reacted at a room temperature for 5 hours. Then, 1.5 g of hexadecylamine was added and continued reacting at a room temperature. After completion of the reaction for 3.5 hours, 5 g of polytrifluoromethyltrimethylsilane was added to obtain a prepolymer polyamic acid solution having a solid content of 10%.

The prepolymer polyamic acid was uniformly coated onto a substrate, then heated to 150° C. for 2 hours, and further heated to 300° C. for 2 hours, to obtain a liquid crystal alignment film.

The adhesion of the prepared liquid crystal alignment film was measured by the adhesion tester according to the GB 1720-1979 test standard. The experimental result showed that its adhesion may exceed level 1.

The pretilt angle of the liquid crystal alignment film was measured by PAT-20 type pretilt angle tester from Changchun Liancheng Instrument Co., Ltd. according to crystal rotation method. The experimental result showed that the pretilt angle was 3° to 5°.

The thermal stability of the liquid crystal alignment film was measured by TG (TG209C, NETZSCH, Germany) thermogravimetric analyzer. The temperature range was from 40° C. to 700° C., and the heating rate was selected to be 10 K/min. The result showed that a significant mass loss existed at 550° C. or above, and the mass loss at 700° C. or less merely was 30%. Therefore, its thermal stability is better.

In addition, the test results of the light transmittance and water absorbability of the liquid crystal alignment film showed that the light transmittance of the liquid crystal alignment film was 96%; the water absorption merely was 3800 ppm at 25° C. and 18% humidity for 24 hours. The above performances were superior to those of the existing alignment film of polyimide material.

In a comparative embodiment of the present disclosure, in N-methylpyrrolidone, 150 g of 4,4′-(2-(3′,5′-dimethyl-phenyl)-1,4-phenoxy)-phthalic anhydride, 100 g of 4,4-diaminodiphenyl ether and 0.69 g of isocyanatopropyltrimethoxysilane were dissolved and reacted at a room temperature for 5 hours. After completion of the reaction for 5 hours, 5 g of polytrifluoromethyltrimethylsilane was added to obtain a prepolymer polyamic acid solution having a solid content of 10%.

The prepolymer polyamic acid was uniformly coated onto a substrate, then heated to 150° C. for 2 hours, and further heated to 300° C. for 2 hours, to obtain a liquid crystal alignment film.

The adhesion of the prepared liquid crystal alignment film was measured by the adhesion tester according to the GB 1720-1979 test standard. The experimental result showed that its adhesion was level 3.

The pretilt angle of the liquid crystal alignment film was measured by PAT-20 type pretilt angle tester from Changchun Liancheng Instrument Co., Ltd. according to crystal rotation method. The experimental result showed that the pretilt angle was 1° to 2°.

The thermal stability of the liquid crystal alignment film was measured by TG (TG209C, NETZSCH, Germany) thermogravimetric analyzer. The temperature range was from 40° C. to 700° C., and the heating rate was selected to be 10 K/min. The result showed that a significant mass loss existed at 450° C. or above, and the mass loss at 700° C. or less was 55%. Therefore, its thermal stability is worse.

In addition, the test results of the light transmittance and water absorbability of the liquid crystal alignment film showed that the light transmittance of the liquid crystal alignment film was 87%; the water absorption was 25000 ppm at 25° C. and 18% humidity for 24 hours. The above performances were worse than those of the existing alignment film of polyimide material prepared by the above Embodiments.

The description of the above embodiments is merely used for helping to understand the method according to the present disclosure and its core idea. It should be noted that one skilled in the art would make improvements and modifications to the disclosure without departing from the principles of the present disclosure. These improvements and modifications should also be regarded as falling into the protection scope of the present disclosure.

1. A liquid crystal alignment film, comprising polyimide having a fluorine-containing group, wherein the polyimide having the fluorine-containing group is polymerized from dicarboxylic anhydride containing one or more fluorine atoms represented by formula (1), a diamine represented by formula (2) and a monoamine represented by formula (3): 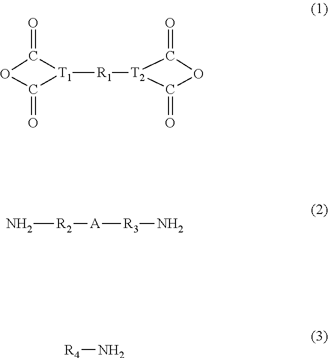
wherein
in the formula (1), T₁ and T₂ each are a linking group in a form of an aromatic ring, a C₃₋₁₀ aliphatic ring, a fluorine-containing aromatic ring or a fluorine-containing C₃₋₁₀ aliphatic ring, and R₁ is a C₁₋₁₀ linear alkylene group or a fluorine-containing C₁₋₁₀ linear alkylene group, an aliphatic cycloalkylene group or a fluorine-containing aliphatic cycloalkylene group, an arylene group or a fluorine-containing arylene group, or an aryloxy group or a fluorine-containing aryloxy group;
in the formula (2), R₂ and R₃ each are a linking group in a form of a C₆₋₁₀ aromatic ring or a C₄₋₈ aliphatic ring, or a single bond, and A is O, N, S, a C₁₋₅ alkylene group, a single bond or a cyano-substituted alkenylene; and
in the formula (3), R₄ is a C₁₂₋₂₀ alkyl group.

2. The liquid crystal alignment film according to claim 1, wherein the monoamine is a C₁₂₋₂₀ chain aliphatic monoamine.

3. The liquid crystal alignment film according to claim 2, wherein the polyimide contains a trifluoromethyl group or a hexafluoropropyl group derived from R₁ in the formula (1), and the polyimide further contains a C₁₂₋₂₀ linear alkyl group derived from R₄ in the formula (3).

4. The liquid crystal alignment film according to claim 1, wherein the dicarboxylic anhydride containing the one or more fluorine atoms is aromatic dicarboxylic anhydride.

5. The liquid crystal alignment film according to claim 1, wherein the dicarboxylic anhydride containing the one or more fluorine atoms is at least one of 4,4′-(hexafluoroisopropylidene)diphthalic anhydride, 4,4′-[2-(3′-trifluoromethyl-phenyl)-1,4-phenylenedioxy]-diphthalic anhydride and 4,4′-[2-(3′,5′-bis(trifluoromethyl)-phenyl)-1,4-phenylenedioxy]-diphthalic anhydride; the diamine is at least one of 4,4-diaminodiphenyl ether, 4,4-diaminodiphenylmethane, diaminomaleonitrile and 3,3′-dimethyl-4,4-diaminodicyclohexylmethane; and the monoamine is at least one of dodecylamine, tetradecylamine, hexadecylamine and octadecylamine.

6. The liquid crystal alignment film according to claim 1, wherein a molar ratio of the diamine to dicarboxylic anhydride containing the one or more fluorine atoms is 1:1.1 to 1:1.3.

7. The liquid crystal alignment film according to claim 1, wherein a molar ratio of the monoamine to the diamine is 1:9 to 1:12.

8. A method for producing the liquid crystal alignment film according to claim 1, comprising:
dissolving dicarboxylic anhydride containing the one or more fluorine atoms, the diamine, and a silane coupling agent into an organic solvent for polymerization;
adding the monoamine for addition polymerization of the monoamine, after the polymerization is completed;
adding fluorine-containing polysiloxane to obtain a prepolymer polyamic acid solution, after the addition polymerization of the monoamine is completed; and
forming a prepolymer polyamic acid on a substrate and curing the prepolymer polyamic acid to obtain the liquid crystal alignment film.

9. The method according to claim 8, wherein the polymerization is performed at a room temperature for 4 to 5 hours.

10. The method according to claim 8, wherein the addition polymerization of the monoamine is performed at a room temperature for 3 to 4 hours.

11. The method according to claim 8, wherein the dicarboxylic anhydride containing the one or more fluorine atoms is at least one of 4,4′-(hexafluoroisopropylidene)diphthalic anhydride, 4,4′-[2-(3′-trifluoromethyl-phenyl)-1,4-phenylenedioxy]-diphthalic anhydride and 4,4′-[2-(3′,5′-bis(trifluoromethyl)-phenyl)-1,4-phenylenedioxy]-diphthalic anhydride; the diamine is at least one of 4,4-diaminodiphenyl ether, 4,4-diaminodiphenylmethane, diaminomaleonitrile and 3,3′-dimethyl-4,4-diaminodicyclohexylmethane; and the monoamine is at least one of dodecylamine, tetradecylamine, hexadecylamine and octadecylamine.

12. The method according to claim 8, wherein the silane coupling agent is at least one of dimethyldimethoxysilane, isocyanatopropyltrimethoxysilane, and isobutyltriethoxysilane.

13. The method according to claim 8, wherein the silane coupling agent is added in an amount of 0.1% to 0.5% by mass based on the total mass of reactants.

14. The method according to claim 8, wherein a molar ratio of the diamine to dicarboxylic anhydride containing the one or more fluorine atoms is 1:1.1 to 1:1.3.

15. The method according to claim 8, wherein a molar ratio of the monoamine to the diamine is 1:9 to 1:12.

16. The method according to claim 8, wherein the fluorine-containing polysiloxane is at least one of polytrifluoromethyltrimethylsilane, fluorine-containing hydroxy polysiloxane, fluorine-containing octamethylcyclotetrasiloxane and polydimethylsiloxane.

17. The method according to claim 8, wherein the prepolymer polyamic acid solution has a solid content of 1% to 10%.

18. The method according to claim 8, wherein the curing is performed through: heating the prepolymer polyamic acid to 120° C. to 150° C. for 2 to 3 hours, and then heating the prepolymer polyamic acid to 250° C. to 300° C. for 2 to 3 hours.

19. A substrate, comprising the liquid crystal alignment film according to claim 1.

20. A display device, comprising the substrate according to claim 19.
